(19) United States
(12) Patent Application Publication
(10) Pub. No.: US 2005/0197890 A1
(43) Pub. Date: Sep. 8, 2005

(54) System, method and computer-readable medium for resume management

(76) Inventors: Angel Lu, Taipei (TW); Ezoe Chang, Hsin-Tien City (TW)

Correspondence Address: NATH & ASSOCIATES, 1030 15th STREET, NW, 6TH FLOOR, WASHINGTON, DC, 20005, US

(21) Appl. No.: 10/845,103

(22) Filed: May 14, 2004

(30) Foreign Application Priority Data
Mar. 5, 2004 (TW) 093105975

(51) Int. Cl. G06F 17/60

(52) U.S. Cl. 705/11; 705/1

(57) ABSTRACT

A resume management system utilizes a resume-analyzing unit to receive and analyze different electronic resume formats and to store the collected data acquired from analysis into a resume database. By doing so, the resume management system can integrate the data of the different electronic resume formats. Wherein, the resume-analyzing unit could translate the collected data into the data format conformed to extensible markup language (XML). Moreover, the resume management system utilizes an e-mail sending unit to automatically send e-mails and/or messages to the user and the applicant needed to be informed by the resume management system.

### BACKGROUND OF THE INVENTION

1. Field of the Invention

The invention relates to a kind of information systems, and more particularly to a kind of information systems used for resume records management in the inner of an enterprise.

2. Description of the Prior Art

In the past, when an enterprise wants to recruit, the only way is to publish a posting job advertisement on newspapers. Then, applicants send their resumes to a human resource department of the enterprise. Because formats of the resumes about applicants are not all the same, the human resource department receives resume records and needs to pick up qualified submissions in response to the posting job advertisement by classifying, screening and assembling in manpower. Then, the human resource department sends the qualified submissions to directors of all departments of the enterprise. The directors review the qualified submissions over and then inform the human resource department to inform applicants of interviews. Accordingly, a procedure of paperwork needed and frequent approval and delivery takes a lot of time and cannot meet the need of the enterprise in the present.

With the development of the Internet, the degree of electronifying of enterprises increases day by day. Many procedures of the paperwork that needs delivery are replaced by electronic delivering and granting. Referring to a resume management system, when an enterprise wants to recruit, it can obtain resumes of applicants by registering on a homepage of manpower bank, and the homepage of the enterprise or by a traditional way of receiving resumes from applicants who send their resumes to a human resource department of the enterprise by postal. Then, the human resource department arranges and puts applicants' resumes in files and prints them to send to directors of different departments to review.

Accordingly, recruiting through the Internet only gives the enterprise another way for posting jobs. Employees of the human resource department need to classify submissions in manpower after the applicants' resumes sent to the enterprise. Then, the classified submissions are sent to the directors to review through the paperwork delivery system of the enterprise. The recruit through the Internet not only increases the work for the employees of the human resource department and the time for reviewing resumes but also increases manmade mistakes made by the employees of the human resource department so that some good applicants may be missed. Therefore, there is a need of electronified procedures for classifying or transmitting resumes, arranging interview flow and admission in the inner of the enterprise.

### SUMMARY OF THE INVENTION

The present invention provides an electronic resume management system, method and computer-readable medium. The procedure of paperwork that needs approval and delivery and takes a lot of time can be replaced by file transmitting in the inner network of the enterprise to finish recruiting employment quickly and effectively.

The present invention stores different resume records of different resume formats into a resume database by a resume-analyzing unit in order to unify the resume formats of the enterprise and provide a source to supply electronic resumes of the enterprise.

The present invention sends e-mails or messages on cell phone about changed resume states and interview states in the resume database automatically to recruiters of the human resource department, the directors and the applicants needed to be informed by means of an e-mails sending unit of the resume management system.

The present invention sends resume data, such as conforming with XML, to the resume database and to make some related statistic data form a table for the director to review the effect of the recruiters' performance by means of changing analysis of the resume database of the resume management system.

In accordance with the present invention, a resume management system is disclosed. The resume management system includes a resume database, a resume-analyzing unit, a user interface, an application unit, and an e-mail sending unit. Herein the resume database is used to store at least one resume record. The resume-analyzing unit is connected to the resume database and is used to receive and analyze a plurality of different resume formats of different resume records and to produce the resume record in respond to the resume formats. The user interface is used to receive orders commanded by at least one user to handle the resume record. The application unit is used to connect the user interface to the resume database and to handle the resume record according to the orders commanded by the user to output a revised resume record to the user interface. The e-mail sending unit is used to connect to the resume database and to output the revised resume record.

The present invention further discloses a method for resume management. The resume management method includes receiving and analyzing a plurality of resume formats to produce at least a resume record; storing the resume record to a resume database; receiving at least a user's command related to the resume record; and handling the resume record according to the user's command to output a revised resume record to the user.

The present invention still discloses a computer-readable medium encoded with computer program code for resume management. The program code causes a computer to execute a method including the aforementioned steps and at least includes a first program receiving and analyzing a plurality of resume formats to produce at least a resume record; a second program storing the resume record to a resume database; a third program receiving at least a user's command related to the resume record; and a fourth program handling the resume record according to the user's command to output a revised resume record to the user.

### BRIEF DESCRIPTION OF THE DRAWINGS

The present invention can be best understood through the following description and accompanying drawings wherein:

FIG. 1 is a schematic diagram of connection relationship between the resume management system and peripheral systems in accordance with the present invention;

FIG. 2 is a schematic systemic diagram of the user interface;

FIG. 3 is a schematic systemic diagram of the function of checking resumes of the user interface;

FIG. 4 is a schematic systemic diagram of the function of maintaining resumes of the user interface;

FIG. 5 is a schematic systemic diagram of the function of maintaining interviews of the user interface;

FIG. 6 is a schematic systemic diagram of the function of setting system of the user interface;

FIG. 7 is a schematic systemic diagram of the function of statistic analysis of the resume database of the user interface;

FIG. 8 is a schematic diagram of the function of the e-mail sending unit; and

FIG. 9 is a flow chart of posting jobs by using the resume management system of the present invention.

### DESCRIPTION OF THE PREFERRED EMBODIMENT

Some embodiments of the present invention have detailed descriptions as below. However, beside detail descriptions, the present invention can be broadly used in other embodiments, and the scope of the present invention is not defined by this preferred embodiment, but by the appended claims.

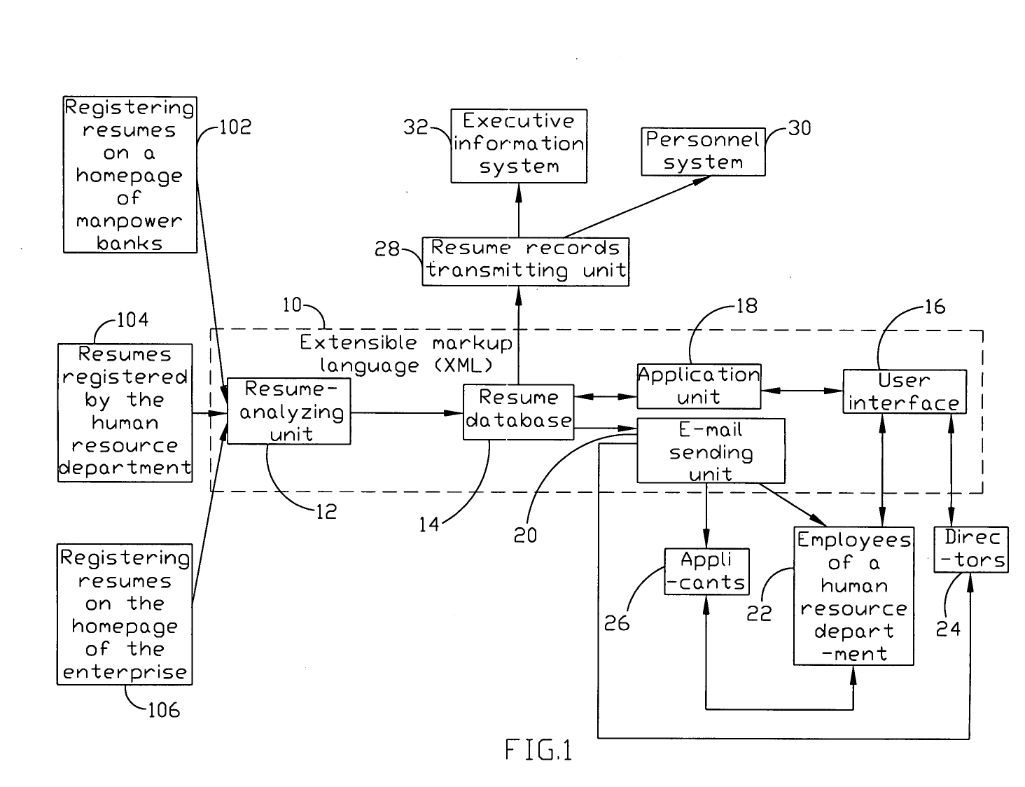

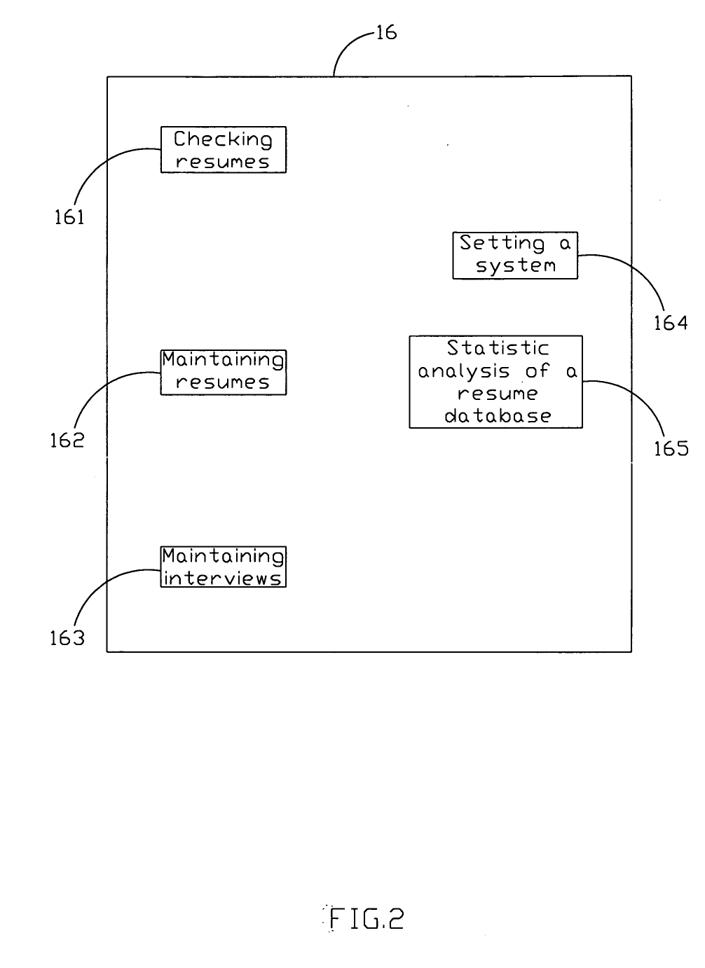

First referring to FIG. 1, a resume management system 10 includes a resume-analyzing unit 12, a resume database 14, a user interface 16, an application unit 18, and an e-mail sending unit 20. The resume-analyzing unit 12 transmits resume records, which are picked up from different resume formats, to the resume database 14 through a record format, such as extensible markup language (XML). The application unit 18 is used to connect the user interface 16 to the resume database 14 and to handle orders commanded by at least one user through the user interface 16 to the resume database 14. The e-mail sending unit 20 is used to connect the resume database 14. When some changes are occurred in the resume database 14, the resume management system 10 sends messages to related persons, such as employees 22 of a human resources department, directors 24 and applicants 26.

Applicants 26 can send their resumes to enterprises by many different ways, as shown in FIG. 1. The applicants 26 can send their resumes to an enterprise by a method of registering resumes on a homepage of manpower banks 102, a method of resumes registered by the human resource department after postal to the enterprise 104 and a method of registering resumes on the homepage of the enterprise 106. Herein manpower banks are web Sites that the applicants can register their resumes through the Internet, such as 104 manpower bank in Taiwan, 51 job manpower bank in China and hotjobs manpower bank in America and so on.

Those electronic resume records transmitted by many different ways have different formats and different field definitions due to themselves different registration formats. This keeps the resume records from directly integrating into a single database. Thus, a manager of the system needs to firstly establish the resume database 14 that contains all kinds of fields for all electronic resume records from all different ways. Then, the resume-analyzing unit 12 analyzes the electronic resume records from all kinds of formats, picking up wanted resume records, and fills them into related fields of the resume database 14 according to the registration formats of the resume database 14. In the present embodiment, the resume-analyzing unit 12 fills the analyzed electronic resume records into the resume database 14 through the record format of extensible markup language (XML). By doing so, the resume records have the feature of data exchange in the network, and are easy for people to read and for computers to search through the user define tags.

When the applicants' 26 resume records are stored in the resume database 14, a user of the resume management system 10, such as the employees 22 of the human resources department and the directors 24, can handle resume records with all kinds of processes and recruit employees with many activities through the user interface 16. When recruiting activities are over, other systems of the enterprise, such as an executive information system (EIS) 32 and a personnel system 30, can copy the records of the resume database 14 in the resume management system 10 by a resume records transmitting unit 28 to their own database for filing and managing personnel records.

Referring to FIG. 2, the user interface 16 of the embodiment includes major function such as a function of checking resumes 161, a function of maintaining resumes 162, a function of maintaining interviews 163, a function of setting a system 164, and a function of statistic analysis of a resume database 165.

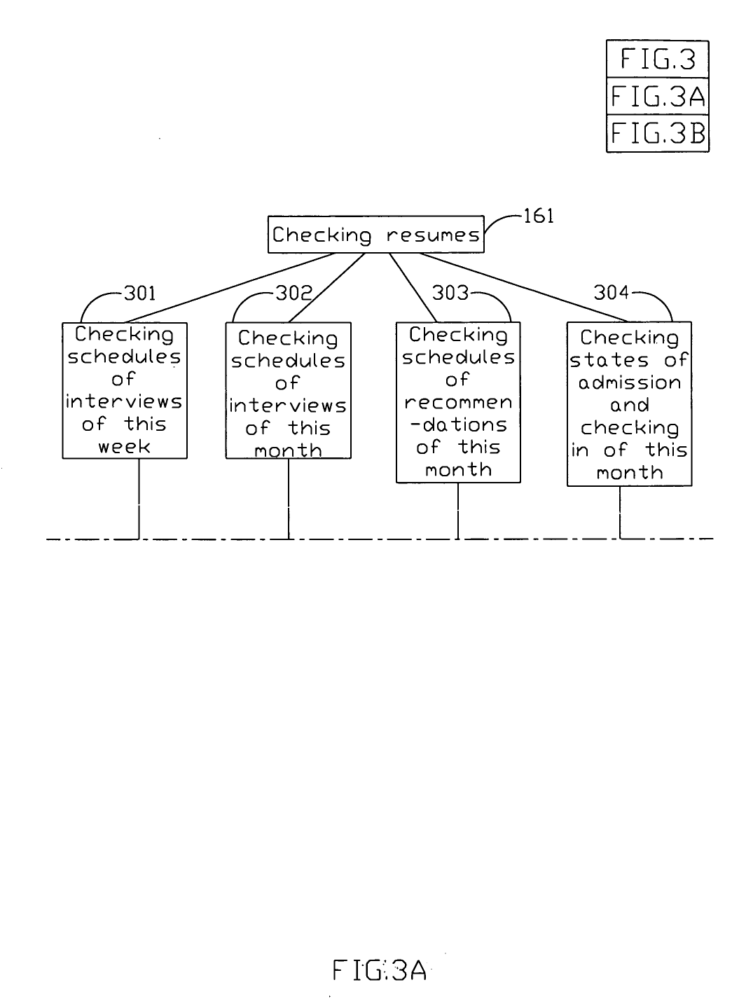

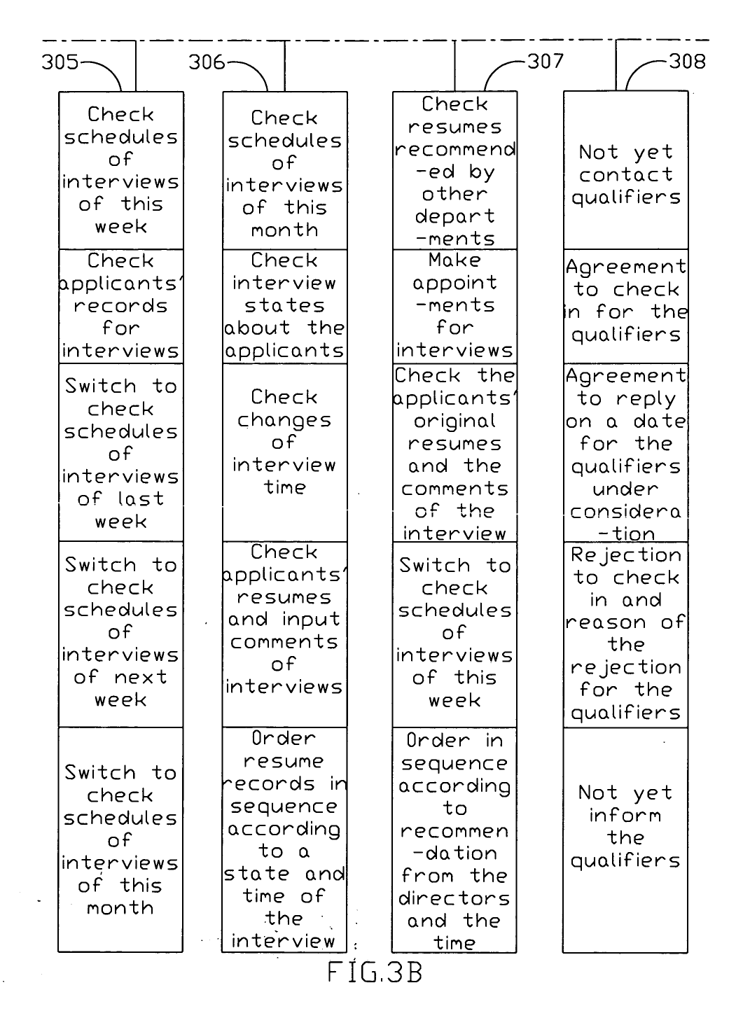

Referring to FIG. 3, a function of checking resumes 161 has a function of checking schedules of interviews of this week 301, a function of checking schedules of interviews of this month 302, a function of checking schedules of recommendations of this month 303 and a function of checking states of admission and checking in of this month 304. In the function of checking schedules of interviews of this week 301, the menu of the function of checking schedules of interviews of this week 305 provides an interface for the directors 24 to let them know clearly the schedules of interviews and applicants' records for interviews in this week. Besides, the directors 24 can switch to check other schedules of interviews through the interface.

In the function of checking schedules of interviews of this month 302, the menu of the function of checking schedules of interviews of this month 306 provides the directors 24 to clearly check the schedules of interviews of this month, interview states about the applicants, changes of interview times, applicants' resumes, to input comments of interviews, and to order resume records in sequence according to a state and time of the interview. Herein the state of the interview for the applicants includes having informed the applicants to interview, non-admission, further interview, admission, waiting to inform, the applicants' cancels, forbidden employment resumes and so on.

In the function of checking schedules of recommendations of this month 303, the menu of the function of checking schedules of recommendations of this month 307 provides the directors 24 for checking resumes recommended by other departments, to make appointments for interviews, to check the applicants' original resumes and the comments of the interview, to switch to check schedules of interviews of this week and to order in sequence according to the recommendations from the directors and the time. In the function of checking states of admission and checking in of this month 304, the menu of the function of checking states of admission and checking in of this month 308 provides the directors 24 for checking the states of admission and checking in of this month and to order in sequence according to the state and date of checking in. Herein the state of admission includes not yet contacting qualifiers, agreement to check in for the qualifiers, agreement to reply on a date for the qualifiers under consideration, rejection to check in and reasons of the rejection for the qualifiers and not yet informing the qualifiers.

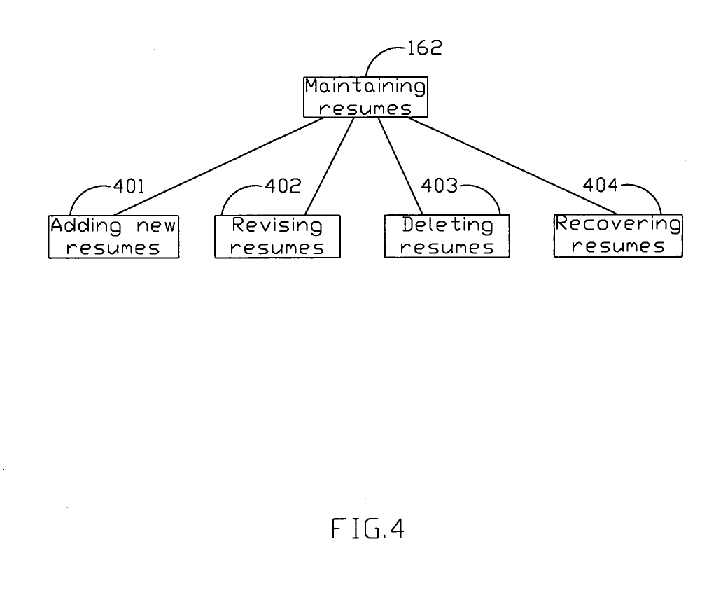

Referring to FIG. 4, a function of maintaining resumes 162 has a function of adding new resumes 401, a function of revising resumes 402, a function of deleting resumes 403 and a function of recovering resumes 404, and allows employees 22 of the human resource department to revise resume records. Herein the function of deleting resumes 403 and recovering resumes 404 allows the employees 22 of the human resource department to delete and recover resume records logistically, but not to substantially delete and recover the resume records in the resume database 14. That is, when a resume record is logistically deleted, it just means other users cannot see the deleted resume record but the employees 22 of the human resource department.

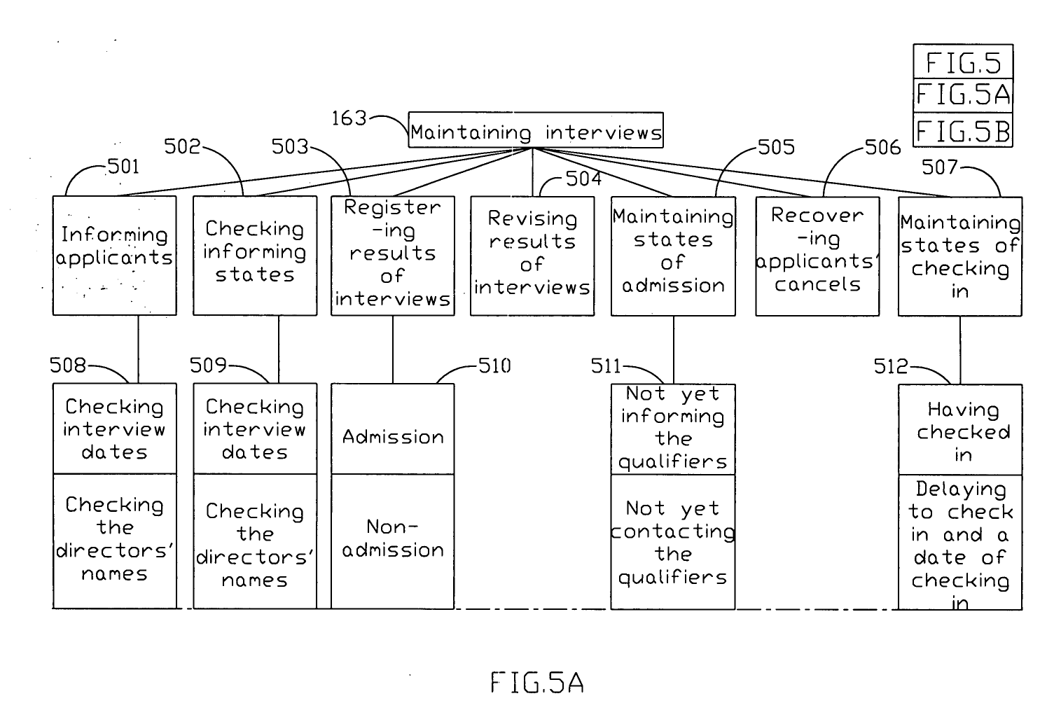

Referring to FIG. 5, a function of maintaining interviews 163 has a function of informing applicants 501, a function of checking informing states 502, a function of registering results of interviews 503, a function of revising results of interviews 504, a function of maintaining states of admission 505, a function of recovering applicants' cancels 506 and a function of maintaining states of checking in 507. Herein the function of informing applicants 501 allows the employees 22 of the human resource department to contact the applicants 26 with whom the directors 24 make an appointment, and to register the interview time. As shown in the menu of the function of informing applicants 508, a function of informing applicants further includes a checking image that can supply the employees 22 of the human resource department for a function of checking interview dates, a function of checking the directors' names, a function of checking the applicants' names, a function of checking the applicants' original resumes, and a function of checking the applicants' states. Herein the applicants' states include the time of agreement to interview for the applicants, having left message to the applicants and contacting times, keeping on contacting the applicants and contacting times, having used e-mails to inform the applicants and contacting times, agreement to reply on a date for the applicants under consideration and having found a job for the applicants.

The function of checking informing states 502, as shown in the menu of the function of checking informing states 509, allows the employees 22 of the human resource department to check interview dates for the applicants 26 informed by the employees 22 of the human resource department, the directors 24 in charge of interview, the names and original resumes for the applicants 26. The function of checking informing states 502 can also allow the employees 22 of the human resource department to change interview times confirmed by the applicants 26. The function of registering results of interviews 503 allows the employees 22 of the human resource department to check and register results of interviews for the applicants' 26, as shown in the menu of the function of registering results of interviews 510. The function of registering results of interviews 503 includes admission, non-admission, further interview and recommendation to other departments. Herein the function of registering results of interviews 503 further includes sending letters of thanks to unemployable applicants 26. The function of revising results of interviews 504 allows the employees 22 of the human resource department to revise results of interviews. The states of the function of revising results of interviews 504 also include admission, non-admission, further interview and recommendation to other departments.

The function of maintaining states of admission 505 allows the employees 22 of the human resource department to register the qualifiers' states. As shown in the menu of the function of maintaining states of admission 511, a function of maintaining states of admission 505 includes not yet informing the qualifiers, not yet contacting the qualifiers, agreement to check in and the date of checking in for the qualifiers, agreement to reply on a date for the qualifiers under consideration, rejection to check in and the reasons of the rejection for the qualifiers. The function of recovering applicants' cancels 506 allows the employees 22 of the human resource department to rearrange interview times for the applicants who can not come to participate the interview in the first place. The function of maintaining states of checking in 507 allows the employees 22 of the human resource department to register states of checking in for the qualifiers. The function of maintaining states of checking in 507, as shown in the menu of the function of maintaining states of checking in 512, includes having checked in, delaying to check in and a date of checking in, rejection to check in and the reasons of the rejection for the qualifiers.

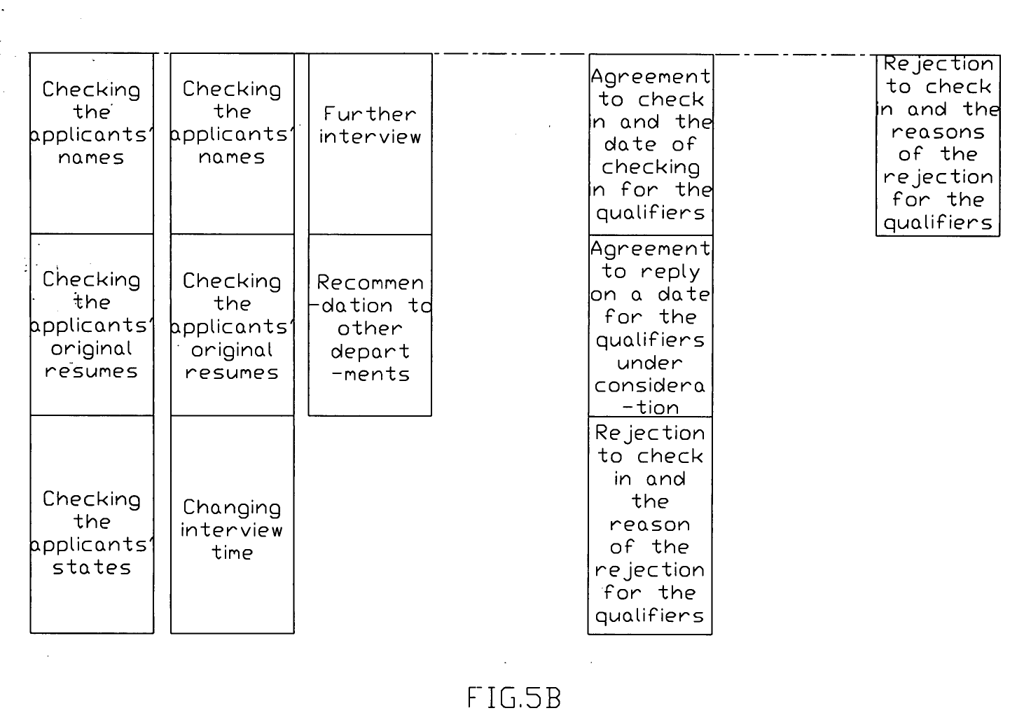

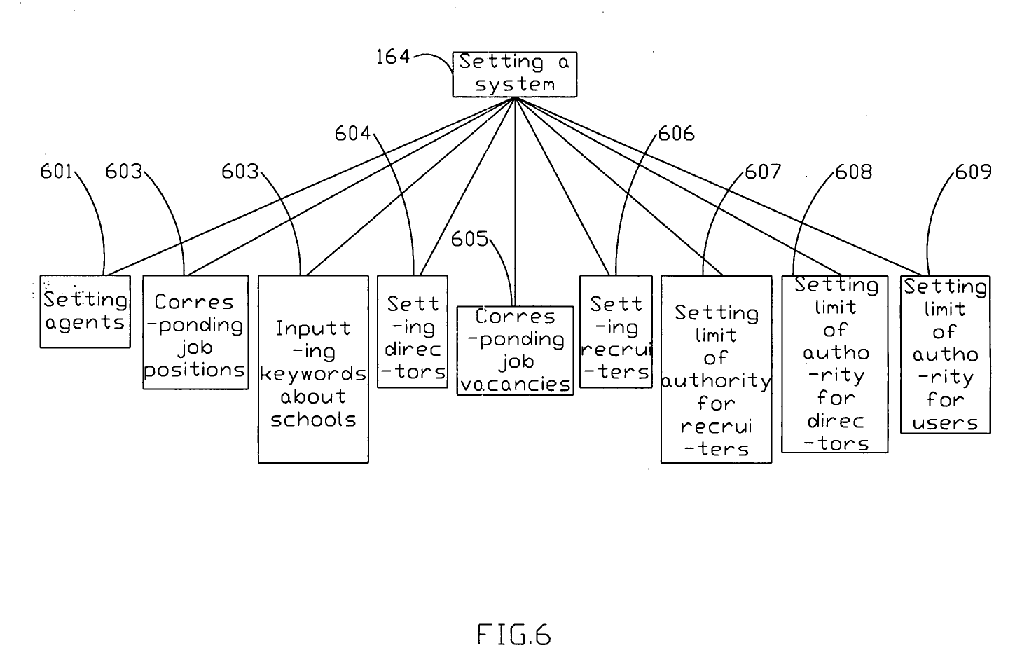

Referring to FIG. 6, a function of setting a system 164 has a function of setting agents 601, a function of corresponding job positions 602, a function of inputting keywords about schools 603, a function of setting directors 604, a function of corresponding job vacancies 605, a function of setting recruiters 606, a function of setting limit of authority for recruiters 607, a function of setting limit of authority for directors 608, and a function of setting limit of authority for users 609. Herein the function of setting agents 601 supplies the directors 24 to set an agent to help the directors 24 make appointments for interviews. The function of corresponding job positions 602 allows the employees 22 of the human resource department to compare the same job position to different position names of different manpower banks. The function of inputting keywords about schools 603 allows the employees 22 of the human resource department to input a school name to search the applicants 26. The function of setting directors 604 allows the employees 22 of the human resource department to set the limit of authority for the directors. The function of corresponding job vacancies 605 allows the employees 22 of the human resource department to set up some job positions needed by those directors of those departments. The function of setting recruiters 606 allows the employees 22 of the human resource department to set those recruiters in charge of those directors. The function of setting limit of authority for recruiters 607 allows the director of the human resource department to set limit of authority of using the resume management system for recruiters. The function of setting limit of authority for directors 608 allows the director of the human resource department to set limit of authority of using the resume management system 10 for directors. The function of setting limit of authority for user 609 allows the director of the human resource department to set limit of authority of using the resume management system 10 for others who are neither directors 24 nor recruiters.

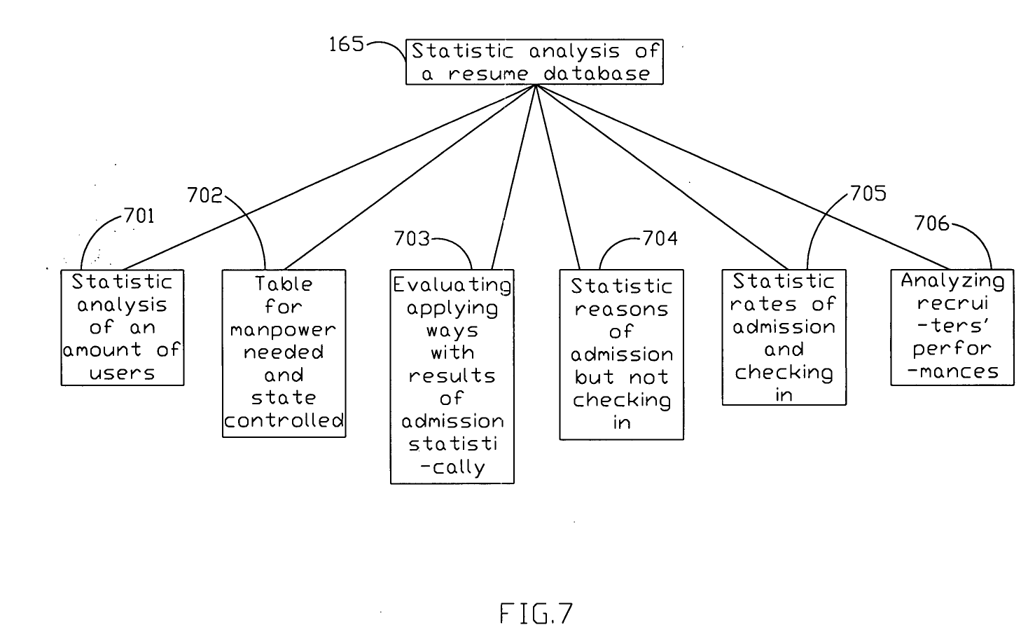

Referring to FIG. 7, a function of statistic analysis of a resume database 165 includes a function of statistic analysis of an amount of users 701, a function of a table for manpower needed and state controlled 702, a function of evaluating applying ways with results of admission statistically 703, a function of statistic reasons of admission but not checking in 704, a function of statistic rates of admission and checking in 705 and a function of analyzing recruiters' performance 706. Herein The function of statistic analysis of an amount of users 701 can check how many times the directors of different departments have used this system and which one has used the system on that day. The function of a table for manpower needed and state controlled 702 provides the human resource department information about manpower distribution in different departments and whether manpower is enough or not. The function of evaluating applying ways with results of admission statistically 703 allows the human resource department to analyze different applying ways so as to know which way is the most effective advertisement. The function of statistic reasons of admission but not checking in 704 provides a method of analyzing reasons for the applicants 26 who are qualified but not checking in. The function of statistic rates of admission and checking in 705 can analyze rates of admission and checking in every month. The function of analyzing recruiters' performances 706 provides the director of the human resource department a method to analyze the recruiters' performances.

An e-mail sending unit 20 of the resume management system 10 connects to the resume database 14. Through wire or wireless of the internal or external of the enterprise network, the e-mail sending unit 20 sends the related data to corresponding people by such as e-mails, ICQ, and messages and so forth. The content or topic of the e-mails could include confirming interview times, changing interview times, sending letters of thanks for interviews and informing about qualifiers' rejection to check in. And, the e-mail sending unit 20 provides a function of setting a time to send e-mails.

A function of confirming interview times 801 allows the resume management system 10 to send e-mails to the directors 24, appointed applicants 26 and recruiters automatically just in time. A daily transmitting message allows the resume management system 10 to automatically send e-mails enclosing applicants' 26 resume records to the directors 24, appointed applicants 26, recruiters and operators in the morning everyday. Herein an e-mail of the function of confirming interview times 801 includes interview times, the applicants' 26 names, the names of the departments, the directors' names, the employee's name appointed to interviews and the recruiter's name.

A function of changing interview times 802 allows the resume manage system 10 to send e-mails to the directors 24, appointed applicants 26, recruiters after the employees 22 of the human resource department changes interview time later. Herein the e-mail of the function of changing interview time 802 includes interview times, the applicants' 26 names and the directors' 24 names.

A function of sending letters of thanks for interviews 803 allows the resume management system 10 to send letters of thanks to the applicants who come for interview but not admission. A function of informing about qualifiers' rejection to check in 804 allows the resume management system 10 to automatically send e-mails to the directors 24 and recruiters after qualifiers reject to check in. Herein the e-mail of the function of informing about qualifiers' rejection to check in 804 includes applicants' names 26, admission time, time of rejection to check in and reasons for rejection to check in.

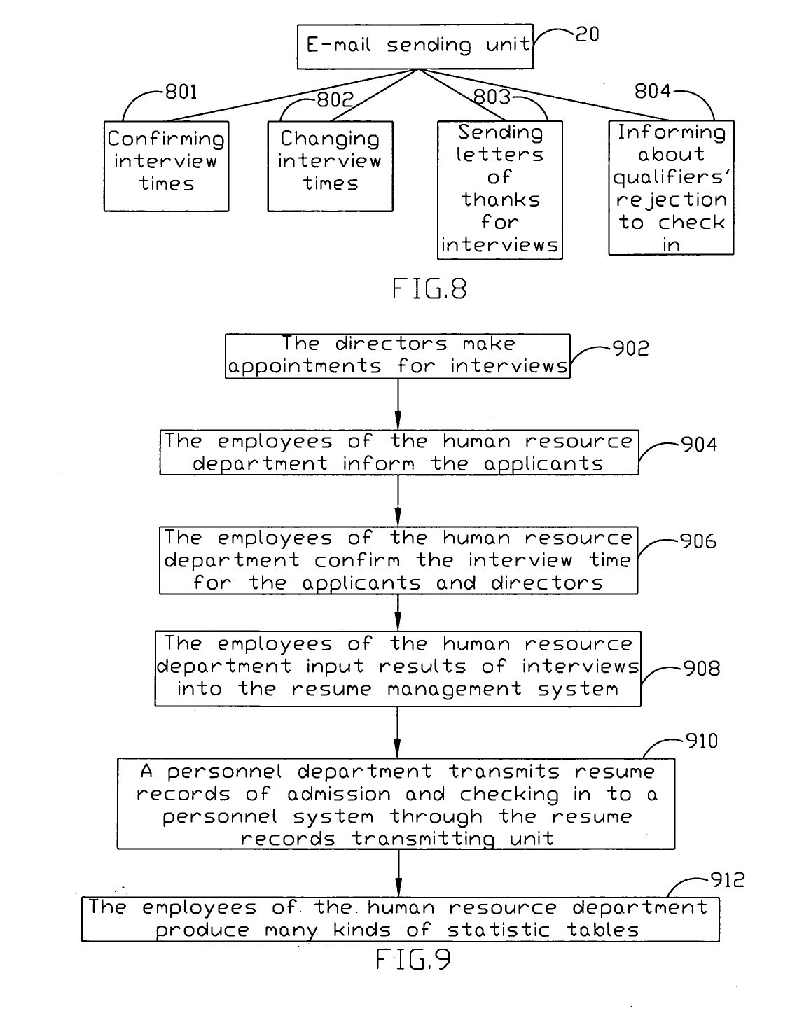

Referring to FIG. 9, a flow chart of posting jobs by using the resume management system 10 in accordance with the present invention is illustrated. In appointed interview step 902, the user interface of the resume management system receives that the directors make appointments for the applicants and time for interviews. In contacting step 904, informing the employees of the human resource department to inform the applicants after confirming with the directors. In confirming time step 906, receiving the interview time confirmed by the applicants and directors and inputted by the employees of the human resource department. After the directors finish the interviews for the applicants, as shown in inputting results of interviews step 908, receiving the results of the interviews inputted by the employees of the human resource department into the resume management system. In transmitting into personnel system step 910, transmitting resume records of admission and checking in from the resume management system to a personnel system through the resume records transmitting unit. In producing tables step 912, producing many kinds of statistic tables by the function of statistic analysis of a resume database 165 (usually done by the human resource department).

Another preferred embodiment in accordance with the present invention is a computer-readable medium encoded with computer program code for resume management. The program code causes a computer to execute a method including the aforementioned steps and at least includes a first program receiving and analyzing a plurality of resume formats to produce at least a resume record; a second program storing the resume record to a resume database; a third program receiving at least a user's command related to the resume record; and a fourth program handling the resume record according to the user's command to output a revised resume record to the user.

Further, the plurality of resume formats correspond to a plurality of resume registration formats. The first program is utilized to integrate the plurality of resume formats into a simple resume registration format. And, the first program could establish the resume records by employing XML.

The preferred embodiment described above is only used to illustrate the present invention, not intended to limit the scope thereof. Many modifications of the preferred embodiment can be made without departing from the spirit of the present invention.

1. A system for resume management, said system comprising:
a resume-analyzing unit, receiving and analyzing a plurality of electronic resumes, and acquiring a plurality of resume records included in said plurality of electronic resumes;
a resume database, connecting to said resume-analyzing unit, said resume database storing said plurality of resume records;
a user interface, receiving at least one order commanded by a user that relates to said plurality of resume records;
an application unit, connecting with said resume database and said user interface, said application unit handling said plurality of resume records according to said orders commanded by the user and outputting a plurality of revised resume records to said user interface; and
an e-mail sending unit, connecting to said resume database to output said plurality of revised resume records.

2. The system of claim 1, wherein said plurality of electronic resumes correspond to a plurality of resume registration formats, and said plurality of resume records correspond to a simple resume registration format.

3. The system of claim 1, wherein said resume-analyzing unit employs XML to establish said plurality of resume records.

4. The system of claim 1, wherein said user interface provides a plurality of functions comprising at least one of followings: a function of checking resumes, a function of maintaining resumes, a function of maintaining interviews, a function of setting a system, a function of statistic analysis of a resume database, or combination of these functions.

5. The system of claim 4, wherein said function of checking resumes comprises a plurality of checking functions comprising at least one of followings: a function of checking schedules of interviews, a function of checking schedules of recommendations, a function of checking states of admission and checking in, or combination of these functions.

6. The system of claim 4, wherein said function of maintaining resumes comprises at least one of followings: a function of adding new resumes, a function of revising resumes, a function of deleting resumes, a function of recovering resumes, or combination of these functions.

7. The system of claim 4, wherein said function of setting a system comprises a function of setting limit of authority for a user, said user comprises at least one of following groups: director agents, directors, recruiters, or combination of these groups.

8. The system of claim 4, wherein said function of statistic analysis of a resume database comprises at least one of followings: a function of statistic analysis of an amount of users, a function of a table for manpower needed and state controlled, a function of evaluating applying ways with results of admission statistically, a function of statistic reasons of admission but not checking in, a function of statistic rates of admission and checking in, a function of analyzing recruiters' performances, or combination of these functions.

9. The system of claim 1, wherein said e-mail sending unit is utilized to set a time to send an e-mail through the Internet.

10. A method for resume management, said method comprising:
receiving and analyzing a plurality of resume formats to produce at least a resume record;
storing said plurality of resume records to a resume database;
receiving at least a user's command related to said plurality of resume records; and
handling said plurality of resume records according to said plurality of user's commands to output a plurality of revised resume records to at least one corresponding said users.

11. The method of claim 10, wherein said plurality of resume formats correspond to a plurality of resume registration formats, and said plurality of resume records correspond to a simple resume registration format.

12. The method of claim 10, wherein said plurality of resume records are conformed to XML.

13. The method of claim 10, wherein at least one of sources of said resume records comes from one of followings: resume records registered on a homepage of manpower banks, those registered by a human resource department and those registered on the homepage of an enterprise.

14. The method of claim 10, wherein said user's command executes at least one of followings: a function of checking resumes, a function of maintaining resumes, a function of maintaining interviews, a function of setting a system, a function of statistic analysis of a resume database or combination of these functions.

15. The method of claim 10, further comprising outputting said revised resume record through an e-mail.

16. The method of claim 15, wherein the content of said e-mail could comprise at least one of followings: confirming interview times, changing interview times, sending letters of thanks for interviews, informing about qualifiers' rejection to check in, and said e-mail can be sent at a setting time.

17. A computer-readable medium encoded with computer program code for resume management, the program code comprising:
a first program, receiving and analyzing a plurality of resume formats to produce at least a resume record;
a second program, storing said plurality of resume records to a resume database;
a third program, receiving at least a user's command related to said plurality of resume records; and
a fourth program, handling said plurality of resume records according to said user's command to output a revised resume record to said user.

18. The computer-readable medium of claim 17, wherein said plurality of resume formats correspond to a plurality of resume registration formats, and said plurality of resume records correspond to a simple resume registration format.

19. The computer-readable medium of claim 17, wherein said plurality of resume records are conformed to XML.
